(19) United States
(12) Patent Application Publication
(10) Pub. No.: US 2019/0093593 A1
(43) Pub. Date: Mar. 28, 2019

(54) METHOD FOR OPERATING AN INJECTOR

(71) Applicant: FEV Europe GmbH, Aachen (DE)

(72) Inventors: Christian Jörg, Herzogenrath (DE); Thorsten Schnorbus, Winterberg (DE); Joschka Schaub, Aachen (DE)

(21) Appl. No.: 16/122,001

(22) Filed: Sep. 5, 2018

(30) Foreign Application Priority Data
Sep. 5, 2017 (DE) 102017120416.4

(51) Int. Cl. F02D 41/40; F02D 41/20

(52) U.S. Cl. CPC F02D 41/401; F02M 51/0603; F02D 41/2096

(57) ABSTRACT

Method for operating an injector, comprising the steps of generating (S201) a digital injection profile by combining trapezoidal individual injection operations which are matched to a prespecified target injection profile (200); and generating (S202) an electrical actuating signal for the injector on the basis of the generated digital injection profile and the actuating parameters of the injector.

### CROSS-REFERENCE TO RELATED APPLICATIONS

This application claims priority to DE 102017120416.4 filed Sep. 5, 2017.

### FIELD OF THE INVENTION

The present invention relates to a method for operating an injector, and to a controller for actuating an injector.

### BACKGROUND OF THE INVENTION

Document DE 10 2007 012 604 A1 relates to a method for controlling an injection operation of an injector of a direct-injection internal combustion engine, and also to a direct-injection internal combustion engine. The combustion control arrangement calculates a hydraulic injection profile which is intended to lead to a thermodynamically optimized combustion rate course. The injection profile generated in this way is present in the form of a continuously shaped profile which initially cannot be realized by conventional injector technology.

The object of the present invention is to realize any desired fuel injection profiles using conventional injectors.

### SUMMARY OF THE INVENTION

According to a first aspect, the object is achieved by a method for operating an injector, comprising the steps of generating a digital injection profile by combining trapezoidal individual injection operations which are matched to a prespecified target injection profile; and generating an electrical actuating signal for the injector on the basis of the generated digital injection profile and the actuating parameters of the injector. The trapezoidal individual injection operations are matched, for example, in such a way that as small a deviation as possible between the course of the injected fuel mass of the target injection profile and the course of the injected fuel mass of the digital injection profile results. For the purpose of matching to the target injection profile, the duration and the time of the respective trapezoidal individual injection operations can be changed. Changing the duration and the time of the respective trapezoidal individual injection operations can be carried out until as small a deviation as possible between the target injection mass profile (course of the injected fuel mass on the basis of the target injection profile) and the actual course of the injected fuel mass of the digital injection profile results. The actuating parameters of the injector comprise, for example, a time offset of the start of injection in relation to the actuating signal, a fuel pressure in the injector or a minimum interval period between the individual injection operations. The method achieves the technical advantage that any desired fuel injection profiles can be generated, the said fuel injection profiles deviating from a trapezoidal shape. The injectors used can be commercially available injectors which generate a trapezoidal fuel injection profile given normal actuation.

In a technically advantageous embodiment of the method, generating the digital injection profile is carried out taking into account a minimum interval period between the individual injection operations, a minimum fuel injection quantity and/or injector dynamics. This achieves the technical advantage, for example, that the digital injection profile can be approximated to the target injection profile with a high degree of accuracy.

In a further technically advantageous embodiment of the method, an approximation of the digital injection profile is carried out until the deviation between a target injection mass profile and the calculated injection mass profile is lower than a defined tolerance parameter value. This achieves the technical advantage, for example, that a prespecified degree of accuracy can be ensured during the matching operation.

In a further technically advantageous embodiment of the method, a deviation between the digital injection profile and the target injection profile is calculated on the basis of the sum of the squared deviations. This achieves the technical advantage, for example, that the deviation can be calculated with a small number of calculation steps.

In a further technically advantageous embodiment of the method, the digital injection profile and/or the actuating signal are/is generated depending on the crankshaft angle. This achieves the technical advantage, for example, that actuating signals can be conducted to the injector depending on the crank angle.

In a further technically advantageous embodiment of the method, a digital injection rate trapezoid is successively increased in size with each crankshaft angle step for the purpose of matching to the target injection profile. This achieves the technical advantage, for example, that matching of the digital injection profile is achieved in a simple manner.

In a further technically advantageous embodiment of the method, the injection mass profile is calculated when closing the nozzle needle for the purpose of matching to the target injection profile. This achieves the technical advantage, for example, that the degree of accuracy of the profile matching operation is improved.

In a further technically advantageous embodiment of the method, generating the digital injection profile is carried out taking into account the pressure of the fuel in the rail system. This likewise achieves the technical advantage, for example, that the degree of accuracy of the profile matching operation is improved.

In a further technically advantageous embodiment of the method, generating the actuating signal is carried out on the basis of a characteristic map with which the associated actuating period for the injector is calculated depending on the injected fuel mass and pressure in the distributor tube. This achieves the technical advantage, for example, that the actuating period can be ascertained in a simple and quick manner.

In a further technically advantageous embodiment of the method, when generating the actuating signal, the injection start times of the digital injection profile are shifted in accordance with a specific calibration value for the purpose of taking into account the injector-specific delay time between electrical and hydraulic start of injection. This achieves the technical advantage, for example, that exact actuation of the injector is achieved.

In a further technically advantageous embodiment of the method, the electrical actuating signal is conducted to the injector. This achieves the technical advantage, for example, that the injector can be directly actuated.

According to a second aspect, the object is achieved by a computer program with commands which, when the computer program is being executed by a computer, prompt the said computer to execute the method according to the first aspect. The same technical advantages as achieved by the method according to the first aspect are achieved by the computer program.

According to a third aspect, the object is achieved by a controller for actuating an injector, comprising a first generating module for generating a digital injection profile by combining trapezoidal individual injection operations which are matched to a prespecified target injection profile; and a second generating module for generating an electrical actuating signal for the injector on the basis of the generated digital injection profile and the actuating parameters of the injector. The same technical advantages as achieved by the method according to the first aspect are achieved by the controller.

In a technically advantageous embodiment of the controller, the first generating module is designed to generate the digital injection profile taking into account a minimum interval period between the individual injection operations, a minimum fuel injection quantity and/or injector dynamics. This likewise achieves the technical advantage, for example, that the digital injection profile can be approximated to the target injection profile with a high degree of accuracy.

In a technically advantageous embodiment of the controller, the second generating module is designed to shift the injection start times of the digital injection profile in accordance with a specific calibration value for taking into account the injector-specific delay time between electrical and hydraulic start of injection. This likewise achieves the technical advantage, for example, that exact actuation of the injector is achieved.

### DESCRIPTION OF THE DRAWINGS

Exemplary embodiments of the invention are illustrated in the drawings and will be described in more detail below.

In the drawings:

FIG. 1 shows a schematic view of an injector;

FIG. 2 shows a flowchart for operating an injector;

FIG. 3 shows a course of a setpoint injection rate and a setpoint injection mass as a function of the crank angle;

FIG. 4 shows a course of a target injection profile with a calculated, digital injection profile;

FIG. 5 shows a course of a target injection profile, a calculated, digital injection profile and a calculated actuating signal; and

FIG. 6 shows a schematic view of a controller for an injector.

### DETAILED DESCRIPTION OF THE INVENTION

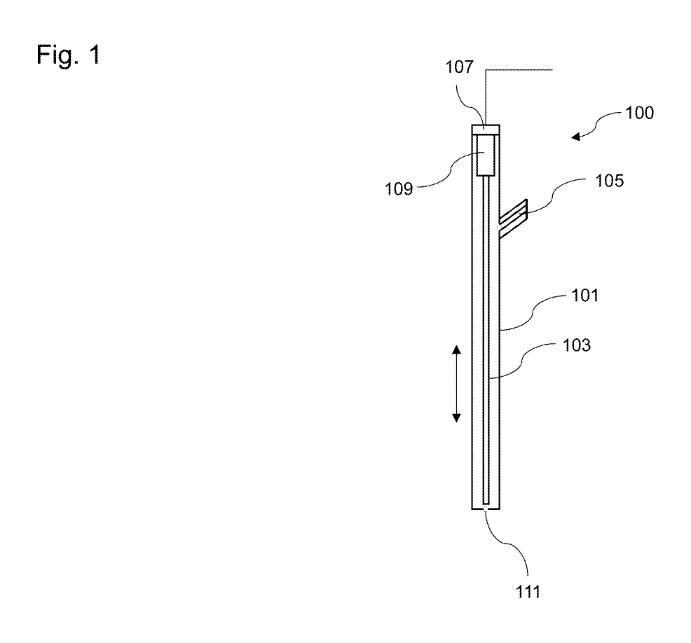

FIG. 1 shows a schematic view of an injector 100. The injector 100 is an injection nozzle for a diesel engine. The injector 100 comprises a nozzle body 101 and a nozzle needle 103. The fuel is supplied to the injector 100 via a high-pressure input 105 under pressure. The injector 100 comprises an electrical interface 107 via which an electrical actuating signal is externally supplied to the injector 100. The actuating signal is converted by a piezo device 109 into a movement of the nozzle needle 103 in the arrow direction. Depending on the actuating signal, the injection hole 111 at the end of the injector 100 is closed or opened by the nozzle needle 103 in the process, so that fuel can be injected into the combustion chamber. The nozzle needle 103 opens only when the injector 100 is actuated by the actuating signal, independently of the applied pressure of the fuel.

Owing to the supplied actuating signal, the injector 100 generates a digital, approximately trapezoidal fuel injection profile. However, thermodynamic advantages in the diesel-engine combustion process can be achieved by a different shape of the hydraulic injection profile.

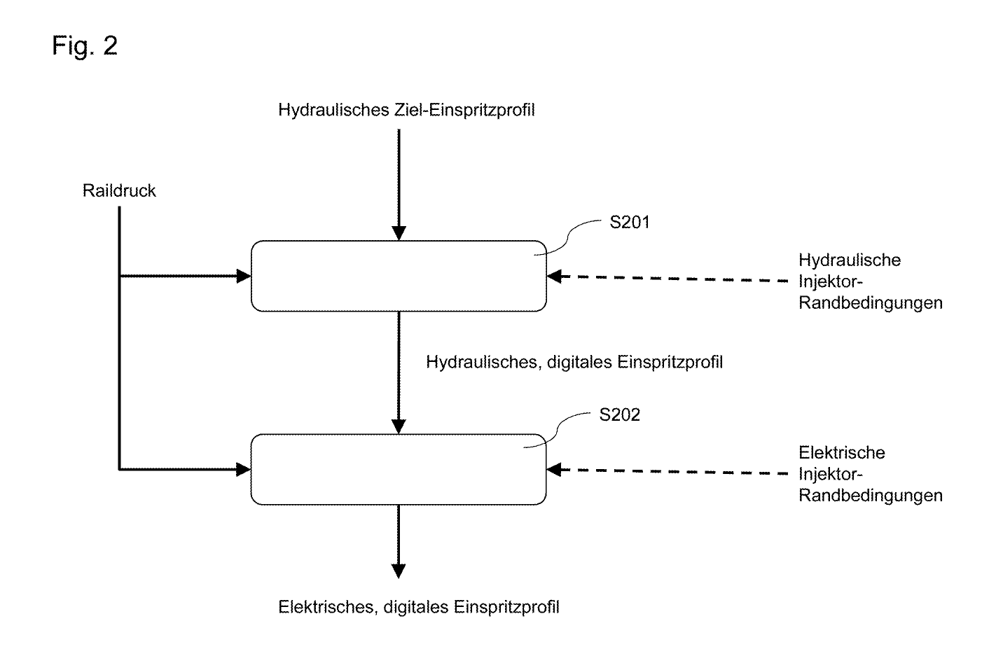

FIG. 2 shows a flowchart for operating the injector 100. By virtue of a digitization method in step S201, a prespecified target injection profile can first be approximated by a plurality of trapezoidal individual injection operations. To this end, a shaped, continuous, hydraulic fuel injection profile is prespecified as a known target injection profile.

The digitization method generates a digital, electrical fuel injection profile, which has as small a deviation as possible, from the prespecified target injection profile. The boundary conditions or actuating parameters of the injector 100, such as a minimum interval period between the individual injection operations (dwell time), a minimum fuel injection quantity and injector dynamics for example, are taken into account when calculating the actuating signal. In addition, the pressure of the fuel in the rail system can be taken into account.

The hydraulic digitization method generates a combination of trapezoidal individual injection profiles which leads to as small a deviation as possible between the prespecified target injection profile and the combined individual injection profiles. The magnitude of the deviation between the digital injection profile and the target injection profile can be calculated, for example, by the sum of the squared deviations.

The combined individual injection profiles produce the digital injection profile for the injector 100. The injection mass course between the continuous target injection profile 200 and digital injection profile is considered for this purpose.

The digitization of the target injection profile 200 is performed depending on the crankshaft angle. Beginning from the start of injection of the continuous target injection profile 200, the digital injection profile is calculated in defined crankshaft angular distances. An individual digital injection rate trapezoid is therefore successively increased in size with each crankshaft angle step (opening of the nozzle needle 103 is simulated) until the deviation between the target injection mass profile and the calculated injection mass profiles is lower than a tolerance parameter value which can be calibrated. The tolerance parameter value is predefined to this end.

With each crankshaft angle step, associated closing of the nozzle needle 103 is simulated since more fuel is injected even during the process of closing the injector. This quantity of fuel is likewise taken into account for calculating the injector mass deviation. As a result, the digital injection profile is approximated to the target injection profile 200 by an iterative procedure, so that an appropriate injection event is found.

If the injection mass required in total has still not been reached after this injection event, further, digital injection events are generated. An injector-specific minimum interval period is maintained between the individual digital injection events.

This interval period is taken into account by the algorithm by way of the algorithm enforcing a zero injection rate, in accordance with the interval period (minimum dwell time) which can be calibrated, immediately after a preceding injection event. As soon as this interval period has elapsed, the next injection profile can be calculated in accordance with the above-described concept, until the entire digital injection profile, which meets the injection mass required in total at the end of the cycle, is produced.

Therefore, this digitization method fully automatically produces a complete, hydraulic, digital injection profile comprising number, times and quantities of the respective injection events.

Each individual, digital injection event is calculated taking into account the hydraulic configuration of the injector 100. The right-hand side, rising branch is determined by the dynamics when the nozzle needle 103 is being opened; and the left-hand side, falling branch is determined by the dynamics when the nozzle needle 103 is being closed. The maximum injection rate is determined by the throughflow coefficient and the applied nozzle pressure (rail pressure). This ensures that the above-described digitization method calculates injection events which can also be realized hydraulically by the given injector 100.

Then, in step S202, the calculated digital injection profile is electrified, so that actual actuating signals for the injector 100 are obtained. In the process, a corresponding, electrical actuating signal (TTL signal) is obtained from the hydraulic, digital injection profile. The actuating signal serves for direct, electrical actuation of the injector 100.

The actuating signal is made up of the electrical actuating start times and actuating periods of the respective injection events. For this purpose, the hydraulic injection start times and the individual injection masses of the respective injection events are first determined from the calculated hydraulic, digital injection profile.

For the purpose of determining the electrical actuating start times, the calculated, hydraulic injection start times of the digital injection profile are shifted in accordance with a specific calibration value for the purpose of taking into account the injector-specific delay time between electrical and hydraulic start of injection. This delay value can be dependent on the rail pressure in the common distributor tube (common rail) for the fuel, which rail pressure is indicated by a curve which can be calibrated.

An injector-specific characteristic map is used for the purpose of determining the electrical actuating periods, the said characteristic map being used to calculate the associated actuating period for the injector depending on the injected fuel mass and pressure in the distributor tube. This characteristic map can be generated by hydraulically surveying the injector 100 by way of the corresponding actuating period being determined for each value pair consisting of fuel mass and pressure.

The electrical actuating start times and actuating periods are defined in this way, so that finally the complete electrical actuating signal can be generated therefrom. This actuating signal for the injector 100 is then present in the form of a crankshaft angle-resolved electrical injection profile which contains all actuating times and periods and the number of injection events.

A specific electrical actuating signal for the injector 100, by way of which actuating signal the prespecified target injection profile is achieved and efficient combustion rate control is rendered possible, can be obtained as a result. A digital injection profile is generated from the continuous, hydraulic target injection course, so that an expensive injector 100, which is capable of rate shaping, for fuel injection can be dispensed with. The method renders possible flexible shaping of the hydraulic injection profile by the injector 100.

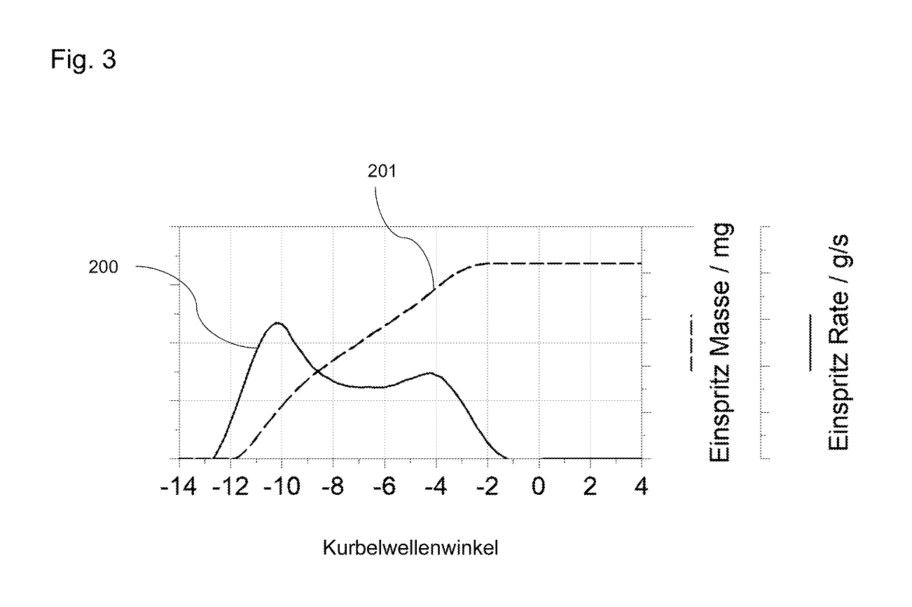

FIG. 3 shows a course of a setpoint injection rate and a setpoint injection mass as a function of the crank angle as target injection profile 200. This target injection profile 200 is prespecified externally as a data set. The target course 201 of the injected fuel mass, that is to say the target injection mass profile, is produced by integrating the target injection profile 201. The target course 201 indicates the total injected mass of the fuel.

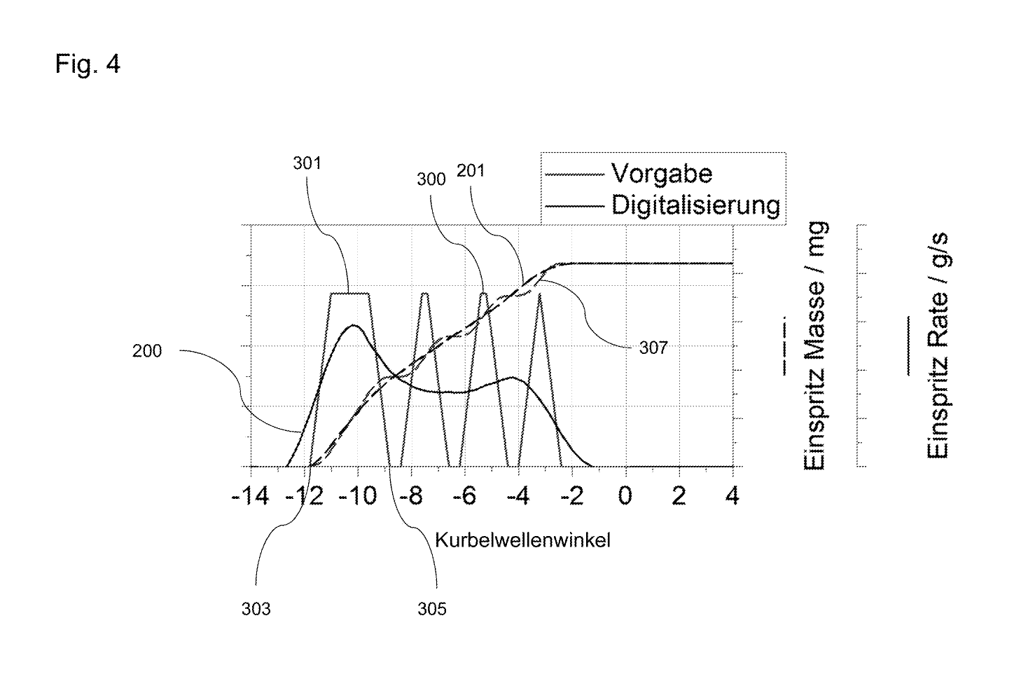

FIG. 4 shows a course of the target injection profile 200 with the calculated digital injection profile 300 which is produced by the trapezoidal individual injection operations 301. The digital injection profile 300 comprises a number of trapezoidal individual injection operations 301 with calculated injection start times 303 and injection end times 305. The course 307 of the actually injected fuel mass, that is to say the injection mass profile, is produced by integrating the digital injection profile 300.

The digital injection profile 300 is obtained by way of step S201 in which the trapezoidal individual injection operations 301 are combined in such a way that they are matched to the prespecified target injection profile 200 such that a small deviation between the temporal courses 201 and 307 of the injected fuel mass is produced.

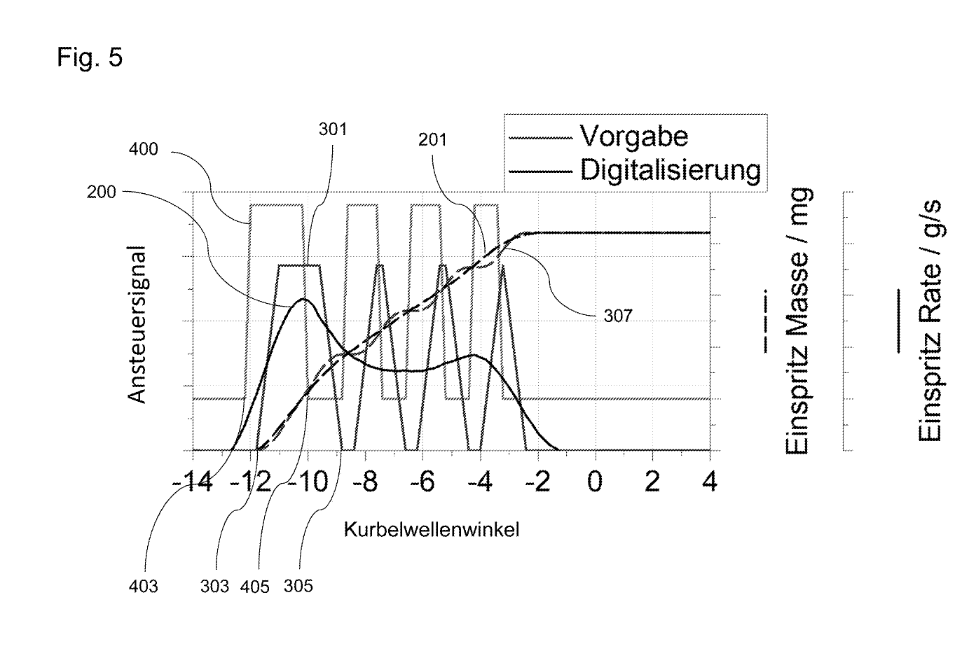

FIG. 5 shows a course of the target injection profile 200, the calculated, digital injection profile 300 and the calculated actuating signal 400. The actuating signal 400 is obtained by way of step S202 in which the electrical actuating signals 400 for the injector 100 are calculated on the basis of the generated digital injection profile 300 and the actuating parameters of the injector 100. The digital injection profile 300 comprises a plurality of individual injection operations 301 with in each case an injection start time 303 and an injection end time 305. In step S201, for example, the actuating start times 403 and actuating end times 405 can be shifted by a prespecified time offset in relation to the injection start times 303 and injection end times 305.

The actuating signal 400 likewise comprises a plurality of trapezoidal individual signals 401 with in each case an actuating start time 403 and an actuating end time 405. The actuating start times 403 and actuating end times 405 are produced from a prespecified, time or crankshaft angle-related shift in the injection start times 303 and injection end times 305.

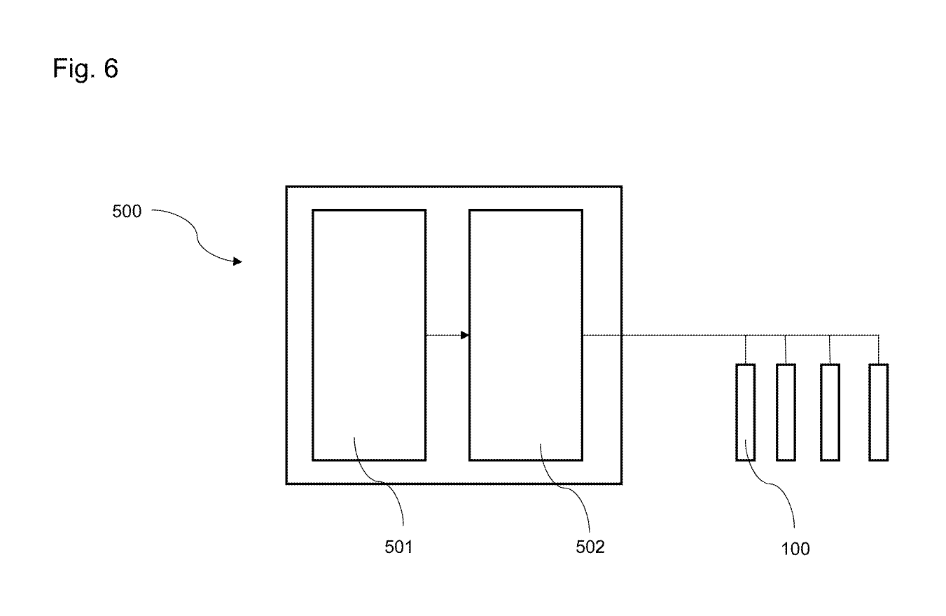

FIG. 6 shows a schematic view of a controller 500 for an injector 100. The controller 500 comprises a first generating module 501 for generating the digital injection profile 300 by combining trapezoidal individual injection operations 301 which are matched to the prespecified target injection profile 200; and a second generating module 503 for generating the electrical actuating signal 400 for the injector 100 on the basis of the generated digital injection profile 300 and the actuating parameters of the injector 100.

The generating modules 501 and 503 can be implemented by software modules which are implemented in the electronic controller 500 for the injector. For this purpose, the controller 500 has a processor for processing the target injection profile, the digital injection profile and the actuating signal, and has an electronic data memory for storing the corresponding data. However, in general, a correspondingly adapted hardware circuit can also be used.

In combination with the combustion rate control (rate shaping) of a diesel engine, this digitization method is highly efficient. The combustion rate controller transfers a thermodynamically optimum combustion rate course to a continuous target fuel injection profile. Combustion rate control with a conventional fuel injector is first rendered possible by the described digitization method. This results in a high degree of relevance for future combustion control strategies.

All features explained and shown in conjunction with individual embodiments of the invention may be provided in a different combination in the subject matter according to the invention so as to realize their advantageous effects at the same time.

All method steps can be implemented by apparatuses which are suitable for executing the respective method step. All functions which are executed by features of the subject matter can be a method step of a method.

The scope of protection of the present invention is provided by the claims and is not restricted by the features explained in the description or shown in the figures.

1. The method for operating an injector,
comprising the steps of:
generating a digital injection profile by combining trapezoidal individual injection operations which are matched to a prespecified target injection profile; and
generating an electrical actuating signal for the injector on the basis of the generated digital injection profile and the actuating parameters of the injector.

2. The method according to claim 1, wherein generating the digital injection profile is carried out taking into account a minimum interval period between the individual injection operations, a minimum fuel injection quantity and/or injector dynamics.

3. The method according to claim 1, wherein an approximation of the digital injection profile is carried out until the deviation between a target injection mass profile and the calculated injection mass profile is lower than a defined tolerance parameter value.

4. The method according to claim 1, wherein a deviation between the digital injection profile (300) and the target injection profile (200) is calculated on the basis of the sum of the squared deviations.

5. The method according to claim 1, wherein the digital injection profile and/or the actuating signal are/is generated depending on the crankshaft angle.

6. The method according to claim 5, wherein a digital injection rate trapezoid is successively increased in size with each crankshaft angle step for the purpose of matching to the target injection profile.

7. The method according to claim 1, wherein the injection mass profile is calculated when closing the nozzle needle for the purpose of matching to the target injection profile.

8. The method according to claim 1, wherein generating the digital injection profile is carried out taking into account the pressure of the fuel in the rail system.

9. The method according to claim 1, wherein generating the actuating signal is carried out on the basis of a characteristic map with which the associated actuating period for the injector is calculated depending on the injected fuel mass and pressure in the distributor tube.

10. The method according to claim 1, wherein, the injection start times of the digital injection profile are shifted in accordance with a specific calibration value for the purpose of taking into account the injector-specific delay time between electrical and hydraulic start of injection.

11. The method according to claim 1, wherein the actuating signal is conducted to the injector.

12. A computer program according to claim 1 with commands which, when the computer program is being executed by a computer, prompts the said computer to execute the method.

13. A controller for actuating an injector,
comprising:
a first generating module for generating a digital injection profile by combining trapezoidal individual injection operations which are matched to a prespecified target injection profile; and
a second generating module for generating an electrical actuating signal for the injector on the basis of the generated digital injection profile and the actuating parameters of the injector.

14. The controller according to claim 13, wherein the first generating module is designed to generate the digital injection profile taking into account a minimum interval period between the individual injection operations, a minimum fuel injection quantity and/or injector dynamics.

15. The controller according to claim 13, wherein the second generating module is designed to shift the injection start times of the digital injection profile in accordance with a specific calibration value for taking into account the injector-specific delay time between electrical and hydraulic start of injection.
